(19) United States
(12) Patent Application Publication
(10) Pub. No.: US 2007/0076006 A1
(43) Pub. Date: Apr. 5, 2007

(54) Detection of displays for information handling system

(76) Inventors: Lawrence E. Knepper, Austin, TX (US); Randall E. Juenger, Belton, TX (US); Thomas P. Lanzoni, Cedar Park, TX (US); Orlando Rigueira, Georgetown, TX (US)

Correspondence Address: HAMILTON & TERRILE, LLP, P.O. BOX 203518, AUSTIN, TX, 78720, US

(21) Appl. No.: 11/239,964

(22) Filed: Sep. 30, 2005

(51) Int. Cl. G06F 13/14

(52) U.S. Cl. 345/520

(57) ABSTRACT

The present invention provides a method and apparatus for automatically determining whether display is attached to a display interface port. In an embodiment of the invention a display can be automatically detected by determining whether an EDID is present and, therefore, whether a display is present at the video interface port. Detection logic is operable to generate a DDC polling signal for use by the EDID circuitry in a display and to receive a DDC data signal generated by the EDID circuitry in response to the polling signal. The DDC data signal generated by the EDID circuitry in the display comprises a header portion and a data portion. The detection logic is operable to examine the header portion of the DDC data signal to determine whether a display is connected to the display interface port.

### BACKGROUND OF THE INVENTION

1. Field of the Invention

The present invention relates in general to the field of information handling systems and, more specifically, to detection of displays used in connection with information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is processed, stored or communicated, and how quickly and efficiently the information may be processed, stored, or communicated. The variations in information handling systems allow for information handling systems to be general or configured for a specific user or specific use such as financial transaction processing, airline reservation, enterprise data storage, or global communications. In addition, information handling systems may include a variety of hardware and software components that may be configured to process, store, and communicate information, and may include one or more computer systems, data storage systems, and networking systems. Information handling systems continually improve in the ability of both hardware components and software applications to generate and manage information.

Many current information handling systems have software or firmware that is used to detect the type of display attached to the system. However, accurate detection of displays can be difficult for the system BIOS and other software, especially at POST or boot time. Many current information handling systems attempt to read Extended Display Identification Data (EDID) from the display. However, if the EDID is not immediately recognized, most information handling systems will generate a message stating that “no display” is detected.

In some information handling systems, the detection of displays is further complicated by the existence of multiple display graphics subsystems. For example, an information handling system may have an integrated graphics subsystem on the main system board with an add-in card in an expansion slot. Alternatively, an information handling system may not have a graphics subsystem on the main system board, but may have two or more graphics cards installed in system expansion slots. In either of the aforementioned configurations, a plugging a display into a graphics port that is not enabled generally results in a blank display.

In most information handling systems, the BIOS is shadowed into the 0xC000 segment in system memory when an attached device is detected to be a display and the EDID can then be read. However, in most current information handling systems the BIOS only enables those graphic subsystems at POST that are “supposed” to be enabled, usually the graphics subsystem that is designated as “primary,” as determined by its location in the system. As will be understood by those of skill in the art, the “int10” call to read the EDID can be made only after the graphics subsystem has been enabled. If there is a display connected to a graphics subsystem other than the primary graphics subsystem, it is not possible to detect it without disabling the primary graphics subsystem and enabling all others in sequence, shadowing the video BIOS, and attempting to read an EDID. This results in a tedious setup procedure that is usually not done in practice.

In view of the foregoing, it is apparent that there is a need for an improved system for detecting displays connected to an information handling system. In particular, there is a need for a system and method to detect whether displays are connected by automatically determining whether an EDID is present.

### SUMMARY OF THE INVENTION

The present invention provides a method and apparatus for automatically determining whether display is attached to a display interface port, including Digital Visual Interface (DVI) ports and Video Graphics Adapter (VGA) ports.

In an embodiment of the invention a display can be automatically detected by determining whether an EDID is present and, therefore, whether a display is present at the video interface port. In this embodiment of the invention, detection logic is operable to generate a DDC polling signal, which may be a DDC clock signal, for use by the EDID circuitry in a display and to receive a DDC data signal generated by the EDID circuitry in response to the polling signal. The DDC data signal generated by the EDID circuitry in the display comprises a header portion and a data portion. The detection logic is operable to examine the header portion of the DDC data signal to determine whether a display is connected to the display interface port.

Various embodiments of the invention can be implemented using protocols and standards established for PCI-Express, as set forth in the PCI-Express Base Specification Revision 1.0, published on Jul. 22, 2002. If a display is detected, the “DISPLAY DETECTED” flag is reflected in the PCI Configuration Space Header for the device. Therefore, during the bus walk, the presence or absence of an attached display can be used by the software to make the decision to enable or not enable the display.

In one embodiment of the invention, the “Base Class” field of the Class Code Register is set to 03h (Display Controller) only if a display is attached. Otherwise, the system defaults to FFh (device does not fit any defined class). By using this procedure, the device is only recognized as a display controller if a display is attached.

Various embodiments of the invention can be implemented on a simple circuit that can be added to any graphics processor or implemented as a small PLA on the graphics board.

Those of skill in the art will understand that many such embodiments and variations of the invention are possible, including but not limited to those described hereinbelow in the detailed description of the invention.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the method and apparatus of the present invention.

FIG. 2 is a block diagram of the functional modules for detecting a display using automatic detection of EDID in accordance with the present invention.

FIG. 3 is a flow chart of the processing steps for detecting a display using automatic detection of EDID in accordance with the present invention.

### DETAILED DESCRIPTION

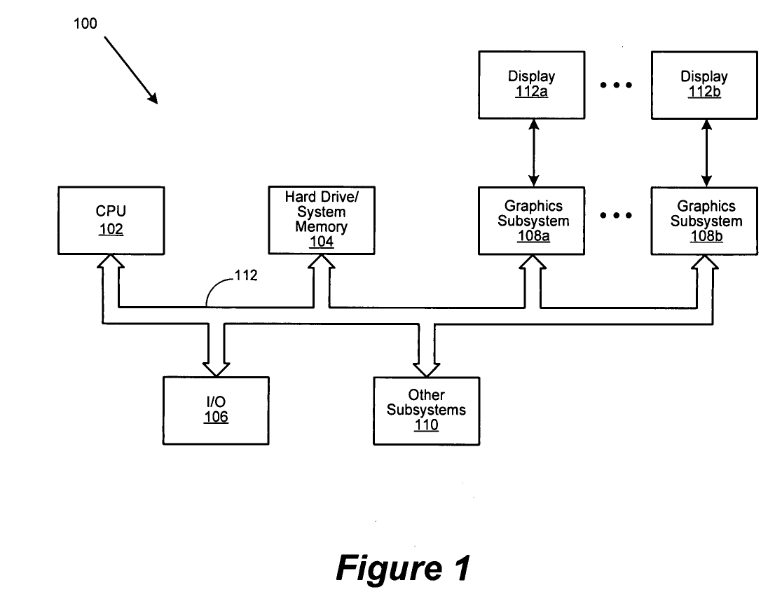

FIG. 1 is a generalized illustration of an information handling system 100 that can be used to implement the method and apparatus of the present invention. The information handling system includes a processor 102, a hard disk drive and system memory 104, an input/output (I/O) interface 106, graphics subsystem(s) 108a, 108b and various other subsystems 110 understood by those of skill in the art. The various system components of the information handling system 100 are interconnected via one or more buses 112. In various embodiments of the invention the bus 112 can be implemented using protocols and standards established for PCI-Express, as set forth in the PCI-Express Base Specification Revision 1.0, as discussed above.

For purposes of this disclosure, an information handling system may include any instrumentality or aggregate of instrumentalities operable to compute, classify, process, transmit, receive, retrieve, originate, store, display, manifest, detect, record, reproduce, handle, or utilize any form of information, intelligence or data for business, scientific, control or other purposes. For example an information handling system may be a personal computer, a network storage device, or any other suitable device and may vary in size, shape performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display.

As discussed above, some information handling systems comprise multiple graphics subsystems that are connected to multiple displays. The graphics subsystems 108a and 108b shown in FIG. 1 are operable to control the operation of displays 112a and 112b, respectively. One or both of the displays 112a, 112b may be connected to the respective graphics subsystems 108a, 108b using a display interface port, such as a DVI port or a VGA port. As will be understood by those of skill in the art, most current displays are capable of exchanging Extended Display Identification Data (EDID) in accordance with standards promulgated by the Video Electronic Standards Association (VESA). The EDID is based on a VESA standard data format containing basic information about a display device and its capabilities including, but not limited to, vendor information, maximum image size, color characteristics, factory pre-set timings, frequency range limits, and character strings for the monitor name and serial number. The information exchanged between the information handling system and the displays 112a or 112b is generally transmitted over a data channel referred to as a Display Data Channel (DDC).

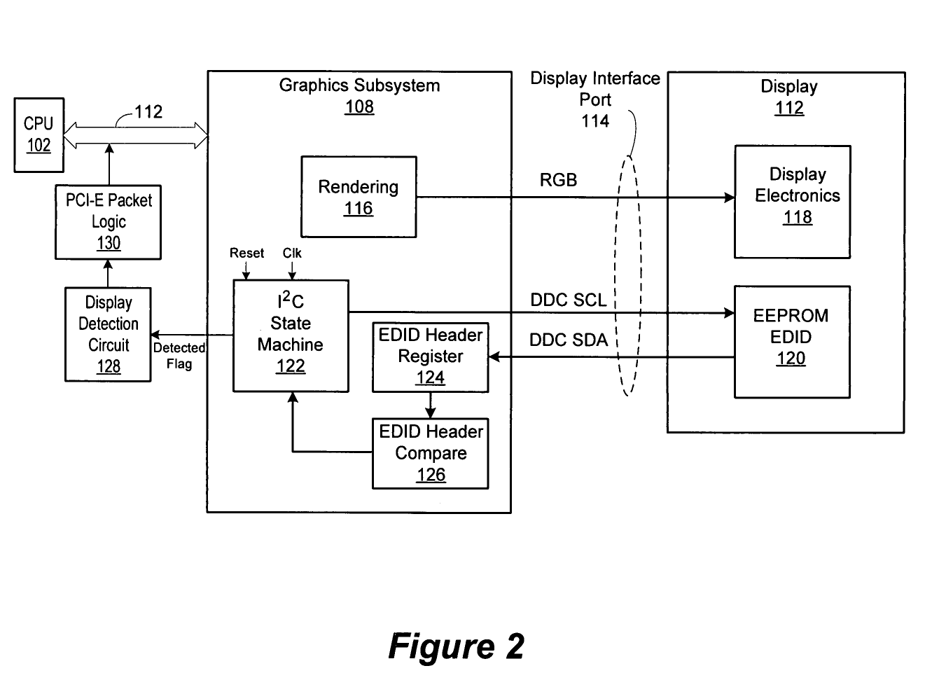

FIG. 2 is an illustration of circuit modules in the graphics subsystems 108a, 108b and the displays 112a, 112b shown in FIG. 1. For discussion purposes the relevant system components will be discussed in association with a generalized graphics subsystem 108 and a display 112 having the detection logic and control circuitry operable to implement the present invention. Referring again to FIG. 2, the display 112 is connected to the graphics subsystem 108 by an appropriate display interface port 114. The graphics subsystem 108 comprises a rendering module 116 that is operable to generate red, green and blue (RGB) signals that are provided to the display electronics 118 to generate a video image on the display 112. The display 112 includes an EEPROM EDID 120 that is operable to receive a DDC serial clock signal (DDC SCL) from I²C state machine 122 and to generate a DDC data signal (DDC SDA) in response thereto. The DDC SDA signal is received by an EDID header register 124 that is operable to extract header information from the DDC SDA signal and to provide the header information to the EDID header compare circuit 126.

Communication of data signals between the display 112 and the data processing circuitry in the graphics subsystem 108 can be implemented using a two-wire serial bus, such as the Inter-Integrated Circuit Bus (I²C Bus) as described in the “I²C-Bus Specification,” Version 2.1, published by U.S. Philips Corporation, January 2000.

In the present invention, the DDC SCL signal is generated by the I²C state machine 122 after a power-on reset or other polling event, thereby causing the EEPROM 120 to generate a DDC SDA signal, which transmits the EDID data block. As will be understood by those of skill in the art, the EDID signal comprises a header portion and a data portion containing data describing the capabilities of the display 112. The EDID header compare module 126 is operable to read enough of the serial data in the DDC SDA signal to detect that a transition has occurred from “0” to “1” and back to “0” (after a dummy write with Data=0x00 to reset the display EDID address pointer to 0x00) indicating that a header is present. Since an EDID header consists of the string “00h, FFh, FFh, FFh, FFh, FFh, FFh, 00h,” the aforementioned transition is sufficient to indicate that the EDID header was detected and, therefore, to indicate that a display is connected to the display interface port. In response to the detected transition, the I²C state machine 122 generates an output signal that is used by the display detection circuit 128 to generate a “display detected” signal. The “display detected” signal is used by the PCI-E packet logic 130 to generate appropriate data packets that provide display status data for use by the data bus 112. The “display detected” indication is not dependent on a valid EDID block or device field. Rather, the “display detected” signal is generated simply on the basis that an EDID header was detected.

If a display is detected as described above, the “DISPLAY DETECTED” flag is reflected in the PCI Configuration Space Header for the device. Therefore, during the bus walk, the presence or absence of an attached display can be used by the software to make the decision to enable or not enable the display.

In one embodiment of the invention, the “Base Class” field of the Class Code Register is set to 03h (Display Controller) only if a display is attached. Otherwise, the system defaults to FFh (device does not fit any defined class). By using this procedure, the device is only recognized as a display controller if a display is attached. This embodiment offers at least two advantages. First, there is no need to enable a graphics subsystem if a display is not attached. Second, this embodiment does not require any architected changes to the PCI Configuration Space as specified in the PCI-Express Specification.

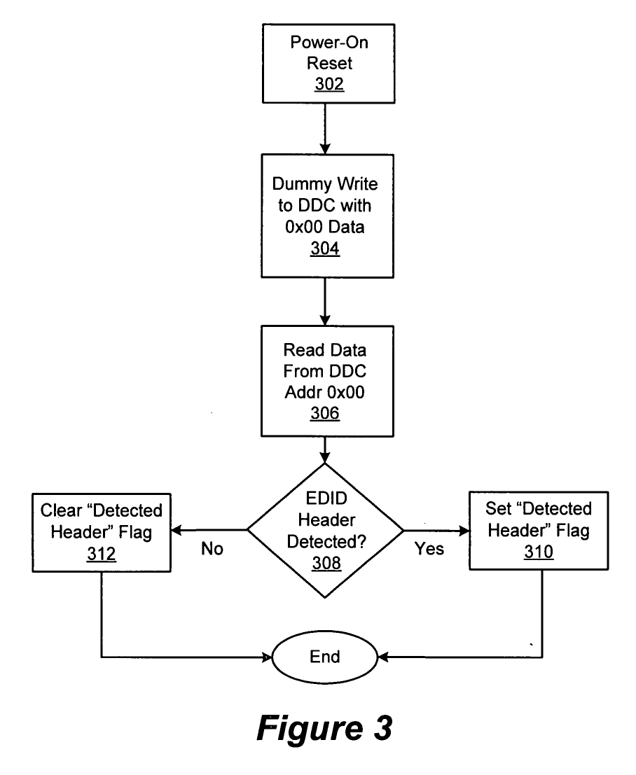

FIG. 3 is a flow chart of the processing steps for detecting a display using automatic detection of EDID in accordance with the present invention. In step 302 a power-on reset or other polling event occurs. In step 304, the I²C state machine 122 initiates a dummy write to DDC with 0x00 data and, in step 306, data is read from DDC address 0x00. In step 308 a test is conducted to determine if an EDID header has been detected. If the result of the test conducted in step 308 indicates that an EDID header has been detected, the “Detected Header” flag is set in step 310 If, however, the result of the test conducted in step 308 indicates that no EDID header has been detected, the “Detected Header” flag is cleared in step 312. In the embodiment described above, the “SET DETECTED FLAG” results in Base Class =03h and the “CLEAR DETECTED FLAG” results in Base Class=FFh.

The present invention offers numerous advantages as will be appreciated by those of skill in the art. The present invention does not depend on a graphics adapter or GPU being initialized, nor the video BIOS being shadowed and executed from the 0xC000 segment, as is required for prior art methods that rely on EDID. The “DISPLAY DETECTED” indication is available to the system BIOS software during the bus walk. Therefore, only the devices that have a display detected will be initialized by the BIOS or the operating system at boot time. If the device that has the display attached is the wrong one, it will still be the one that is initialized. Using the method and apparatus of the present invention, a displayed image is provided regardless of where the display is attached.

Although the present invention has been described in detail, it should be understood that various changes, substitutions and alterations can be made hereto without departing from the spirit and scope of the invention as defined by the appended claims.

What is claimed is:

1. A system for detecting a display attached to an information handling system, comprising:
a graphics system operable to generate a polling signal and to receive a data signal response thereto; and
a display operable to receive said polling signal and generate said data signal in response thereto, said data signal comprising a header portion;
wherein said graphics system further comprises data processing logic operable to detect said header portion of said data signal and to generate a display status signal indicating status of said display.

2. The system of claim 1, wherein said data signal comprises extended display identification data.

3. The system of claim 2, wherein said polling signal comprises a serial clock signal.

4. The system of claim 3, wherein said detected header comprises a plurality of data bits indicating transition from a logic “0” to a logic “1” and back to a logic “0.”

5. The system of claim 4, wherein said display is operably coupled to said graphics subsystem by a digital video interface port operable to communicate extended display identification data.

6. The system of claim 4, wherein said display is operably coupled to said graphics subsystem by a video graphics adapter operable to communicate extended display identification data.

7. A method for detecting a display connected to an information handling system, comprising:
using a graphics system to generate a polling signal and to receive a data signal response thereto;
using a display to receive said polling signal and to generate said data signal in response thereto, said data signal comprising a header portion;
detecting said header portion of said data signal and generating a display status signal indicating status of said display.

8. The method of claim 7, wherein said data signal comprises extended display identification data.

9. The method of claim 8, wherein said polling signal comprises a serial clock signal.

10. The method of claim 9, wherein said detected header comprises a plurality of data bits indicating transition from a logic “0” to a logic “1” and back to a logic “0.”

11. The method of claim 10, wherein said display is operably coupled to said graphics subsystem by a digital video interface port operable to communicate extended display identification data.

12. The method of claim 10, wherein said display is operably coupled to said graphics subsystem by a video graphics adapter operable to communicate extended display identification data.

13. A system for detecting a display attached to an information handling system, comprising:
a graphics system operable to generate a display detection signal and to receive a display data signal in response to said display detection signal; and
detection logic operable to process said a display data signal and to generate a display status signal for use by a data bus of said information handling system;
wherein said display detection signal is used to define a device class for said graphics system in accordance with the configuration protocol of said data bus.

14. The system of claim 13, wherein said data bus comprises a PCI-Express bus.

15. The system of claim 14, wherein said display status signal corresponds to a connected display and said device class is defined as a display controller in accordance with the PCI-Express specification.

16. The system of claim 15, wherein said display status signal corresponds to a lack of a connected display and said device corresponds an undefined device in accordance with the PCI-Express specification.

17. A method for detecting a display connected to an information handling system, comprising:
using a graphics system to generate a display detection signal and to receive a display data signal in response to said display detection signal; and
using detection logic to process said a display data signal and to generate a display status signal for use by a data bus of said information handling system;
wherein said display detection signal is used to define a device class for said graphics system in accordance with the configuration protocol of said data bus.

18. The method of claim 17, wherein said data bus comprises a PCI-Express bus.

19. The method of claim 18, wherein said display status signal corresponds to a connected display and said device class is defined as a display controller in accordance with the PCI-Express specification.

20. The method of claim 18, wherein said display status signal corresponds to a lack of a connected display and said device corresponds an undefined device in accordance with the PCI-Express specification.
